(19) United States
(12) Patent Application Publication
(10) Pub. No.: US 2016/0267623 A1
(43) Pub. Date: Sep. 15, 2016

(54) IMAGE PROCESSING SYSTEM, MOBILE COMPUTING DEVICE INCLUDING THE SAME, AND METHOD OF OPERATING THE SAME

(71) Applicant: Samsung Electronics Co., Ltd., Suwon-si (KR)

(72) Inventor: Jae Sung Heo, Suwon-si (KR)

(21) Appl. No.: 15/000,407

(22) Filed: Jan. 19, 2016

(30) Foreign Application Priority Data
Mar. 12, 2015 (KR) 10-2015-0034301

(51) Int. Cl. G06T 1/20; G06K 9/46; G06T 7/00; G06T 7/20; G09G 5/00

(52) U.S. Cl. CPC G06T 1/20; G06T 7/20; G09G 5/00; G06T 7/0085; G06K 9/4604; G06T 2207/20021; G06T 2200/04; G09G 2330/021

(57) ABSTRACT

An image processing system included in a mobile computing device is provided. The image processing system includes a motion estimation circuit configured to receive and analyze a motion signal and to generate a control signal based on an analysis result, and an image processing circuit configured to selectively decrease power consumption for an image processing operation in response to the control signal.

### CROSS-REFERENCE TO RELATED APPLICATION

This application claims priority under 35 U.S.C. §119(a) from Korean Patent Application No. 10-2015-0034301 filed on Mar. 12, 2015, the disclosure of which is hereby incorporated by reference in its entirety.

### BACKGROUND

Embodiments of the inventive concepts relate to an image processing system, and more particularly, to an image processing system for reducing power consumption when generating and processing an image using motion information, a mobile computing device including the same, and/or a method of operating the same.

It is not less essential to secure a sufficient use time by reducing power consumption than performance for a mobile computing device such as a smart phone or a tablet personal computer (PC). A lot of power is consumed when a mobile computing device generates an image using an embedded camera and processes and displays the image. When a user activates the camera, an image sensor continuously generates images, an image signal processor and an application processor continuously process the images, and a display continuously displays the processed images until the camera is deactivated. However, most of the generated or processed images are not actually used. For instance, when a user wants to capture a still image, a camera and a display continuously operate even before a capture function is started by the user. As a result, power of a mobile computing device is unnecessarily consumed.

### SUMMARY

According to some embodiments of the inventive concepts, there is provided an image processing system included in a mobile computing device. The image processing system includes a motion estimation circuit configured to receive and analyze a motion signal and to generate a control signal based on an analysis result, and an image processing circuit configured to selectively decrease power consumption for an image processing operation in response to the control signal.

When the image processing circuit is an image signal processor, the image signal processor may decrease the power consumption for the image processing operation by deactivating at least one block among a plurality of processing blocks included in the image signal processor. The plurality of processing blocks may include at least one block among a bad pixel correction block, a nose reduction block, a dynamic range compensation block, and an anti-shading block. The motion estimation circuit may determine a current motion state based on the analysis result and may generate the control signal according to the current motion state.

When the image processing circuit is an image sensor which is configured to generate an image having a first frame rate, the image sensor may is configured to generate an image having a second frame rate lower than the first frame rate in response to the control signal.

The motion estimation circuit may predict a future motion state based on the analysis result and may generate the control signal according to the future motion state.

When the image processing circuit is an application processor, the application processor may decrease the power consumption for the image processing operation by deactivating at least one block among a plurality of processing blocks included in the application processor. The plurality of processing blocks may include at least one block among a nose reduction block and an edge enhancement block. The motion estimation circuit may output the control signal when the motion signal is higher than a reference level. The motion signal may be received from a motion sensor included in the mobile computing device.

According to other embodiments of the inventive concepts, there is provided a mobile computing device including a motion sensor configured to sense motion of the mobile computing device for a desired (or, alternatively a predetermined) period of time and to output a motion signal, a motion estimation circuit configured to receive and analyze the motion signal and to generate a control signal based on an analysis result, and an image processing circuit configured to selectively decrease power consumption for an image processing operation in response to the control signal.

The motion estimation circuit may determine a current motion state based on the analysis result and may generate the control signal according to the current motion state. When the image processing circuit is an image signal processor, the image signal processor may decrease the power consumption for the image processing operation by deactivating at least one block among a plurality of processing blocks included in the image signal processor. The plurality of processing blocks may include at least one block among a bad pixel correction block, a nose reduction block, a dynamic range compensation block, and an anti-shading block.

The motion estimation circuit may predict a future motion state based on the analysis result and may generate the control signal according to the future motion state. When the image processing circuit is an image sensor which generates an image having a first frame rate, the image sensor may generate an image having a second frame rate lower than the first frame rate in response to the control signal.

The motion estimation circuit may determine a current motion state based on the analysis result and may generate the control signal according to the current motion state. When the image processing circuit is an application processor, the application processor may decrease the power consumption for the image processing operation by deactivating at least one block among a plurality of processing blocks included in the application processor. The plurality of processing blocks may include at least one block among a nose reduction block and an edge enhancement block. The motion estimation circuit may output the control signal when the motion signal is higher than a reference level.

According to further embodiments of the inventive concepts, there is provided a method of operating a mobile computing device. The method includes receiving and analyzing a motion signal output from a motion sensor included in the mobile computing device and generating a control signal, and selectively decreasing power consumption of an image processing circuit, which processes an image in the mobile computing device, based on the control signal.

### BRIEF DESCRIPTION OF THE DRAWINGS

The above and other features and advantages of the inventive concepts will become more apparent by describing in detail example embodiments thereof with reference to the attached drawings in which:

FIG. 1 is a block diagram of a mobile computing device including an image processing system according to some embodiments of the inventive concepts;

FIG. 2 is a schematic diagram of processing blocks included in an image signal processor illustrated in FIG. 1;

FIG. 3 is a schematic diagram of processing blocks included in an application processor illustrated in FIG. 1;

FIGS. 4 through 6 are diagrams showing the operations of the mobile computing device illustrated in FIG. 1 according to some embodiments of the inventive concepts;

FIG. 7 is a graph explaining the operation of a motion estimation circuit illustrated in FIG. 1;

FIG. 8 is a flowchart of a method of operating a mobile computing device according to some embodiments of the inventive concepts;

FIG. 9 is a flowchart of a method of operating an image signal processor included in a mobile computing device according to some embodiments of the inventive concepts;

FIG. 10 is a flowchart of a method of operating an image sensor included in a mobile computing device according to some embodiments of the inventive concepts;

FIG. 11 is a flowchart of a method of operating an application processor included in a mobile computing device according to some embodiments of the inventive concepts;

FIG. 12 is a block diagram of a data processing system according to some embodiments of the inventive concepts;

FIG. 13 is a block diagram of a computing device according to some embodiments of the inventive concepts;

FIG. 14 is a block diagram of a computing device according to other embodiments of the inventive concepts; and

FIG. 15 is a block diagram of a computing device according to further embodiments of the inventive concepts.

### DETAILED DESCRIPTION OF THE EMBODIMENTS

The inventive concepts now will be described more fully hereinafter with reference to the accompanying drawings, in which embodiments of the present disclosure are shown. The present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

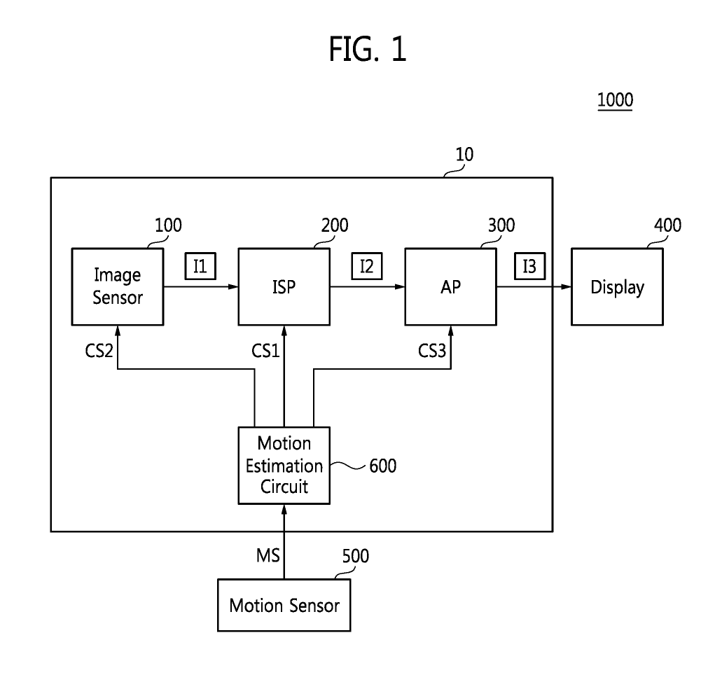

FIG. 1 is a block diagram of a mobile computing device 1000 including an image processing system 10 according to some embodiments of the inventive concepts. The mobile computing device 1000 may include the image processing system 10 and a display 400. The image processing system 10 includes an image sensor 100, an image signal processor (ISP) 200, and an application processor (AP) 300.

The image sensor 100 may convert an optical image into an electrical signal. The image sensor 100 may be a charged coupled device (CCD) image sensor or a complementary metal-oxide-semiconductor (CMOS) image sensor.

The image sensor 100 may include an active pixel area or an active pixel array in which a plurality of pixels are arranged in matrix. Each of the plurality of pixels may include a photoelectric conversion element which generates an electrical signal varying with the quantity of incident light. The image sensor 100 may process the electrical signal to generate a first image I1 and may output the first image I1 to the ISP 200. The first image I1 may have a Bayer pattern including a red color signal, a green color signal, and a blue color signal, but the inventive concepts is not restricted to this example.

The ISP 200 may process the first image I1 transmitted from the image sensor 100. In detail, the ISP 200 may process the first image I1 in Bayer pattern by performing bad pixel correction (BPC), noise reduction, dynamic range compensation, and/or anti-shading on the first image I1, but the inventive concepts is not restricted to this example. The ISP 200 may transmit a second image I2 generated as a result of processing the first image I1 to the AP 300 through an interface (not shown).

The AP 300 may process the second image I2 transmitted from the ISP 200 and may transmit a third image I3 generated as a result of processing the second image I2 to the display 400. In detail, the AP 300 may process the second image I2 received from the ISP 200 by performing noise reduction and edge enhancement on the second image I2, but the inventive concepts is not restricted to this example. The display 400 may display the third image I3 transmitted from the AP 300.

The image processing system 10 may include a motion estimation circuit 600. The motion estimation circuit 600 may analyze a motion signal MS transmitted from a motion sensor 500 included in the mobile computing device 1000 and may generate at least one control signal CS1, CS2, and/or CS3 for controlling power consumption of the image processing system 10 according to the analysis result. The motion estimation circuit 600 may be implemented in a separate chip, as shown in FIG. 1, but the inventive concepts is not restricted to the current embodiments. The motion estimation circuit 600 may be included in the ISP 200 or the AP 300 in other embodiments.

The motion estimation circuit 600 may analyze the motion signal MS received for a desired (or, alternatively a predetermined) period of time, and may determine a current motion state (or level) and/or future motion state (or level) of the mobile computing device 1000 based on the analysis result. When the current motion state and/or the future motion state is equal to or higher than a reference level, the motion estimation circuit 600 may output at least one control signal CS1, CS2, and/or CS3 for decreasing power consumption of the image processing system 10. When at least one of the current motion state and the future motion state is lower than the reference level, the motion estimation circuit 600 may keep the image processing system 10 in the current state of power consumption.

A case that the current motion state and/or the future motion state is equal to or higher than the reference level may refer to a state where an image generated and processed by the image processing system 10 is not actually used. For instance, it may refer to a case that a user is not paying attention to the mobile computing device 1000, such as a case that the user is moving the mobile computing device 1000 to find an object to be shot after driving the image processing system 10 of the mobile computing device 1000.

A case that the current motion state and/or the future motion state is lower than the reference level may refer to a state where an image generated and processed by the image processing system 10 is actually used. For instance, it may refer to a case that a user is paying attention to the mobile computing device 1000, such as a case that the user is not moving the mobile computing device 1000 to make an object to be focused on and take a shot of the object.

An image processing circuit included in the image processing system 10 may refer to at least one among the image sensor 100, the ISP 200, and the AP 300.

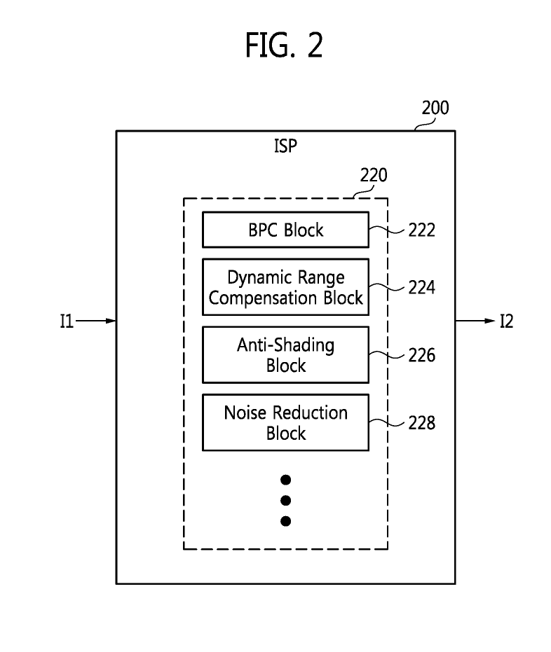

FIG. 2 is a schematic diagram of processing blocks included in the ISP 200 illustrated in FIG. 1. Referring to FIGS. 1 and 2, the ISP 200 may include a processing area 220 including a plurality of processing blocks 222, 224, 226, and 228 that process the first image I1 received from the image sensor 100. The processing blocks 222, 224, 226, and 228 may include the BPC block 222, the dynamic range compensation block 224, the anti-shading block 226, and the noise reduction block 228, but the inventive concepts is not restricted to the current embodiments.

When the first image I1 includes data generated from a bad pixel occurring due to a problem in the manufacturing process of the image sensor 100, the BPC block 222 may correct (or replace) the data generated from the bad pixel using data generated from other adjacent pixels. In order to overcome a problem in that both a dark region and a bright region cannot be effectively represented in the first image I1 at the same time due to dynamic range performance of the image sensor 100, the dynamic range compensation block 224 may process the first image I1 to widen a dynamic range, so that both the dark region and the bright region can be effectively represented in the first image I1 at the same time.

The anti-shading block 226 may compensate for a shading effect occurring due to a lens when the image sensor 100 generates the first image I1. The shading effect is a phenomenon in which the edge of the first image I1 is darker than the center of the first image I1. The noise reduction block 228 may remove noise from the first image I1 to clear the first image I1.

Although only the BPC block 222, the dynamic range compensation block 224, the anti-shading block 226, and the noise reduction block 228 are illustrated as processing blocks in FIG. 2, the processing blocks may include all function blocks involved with image processing operations in a conventional ISP in other embodiments.

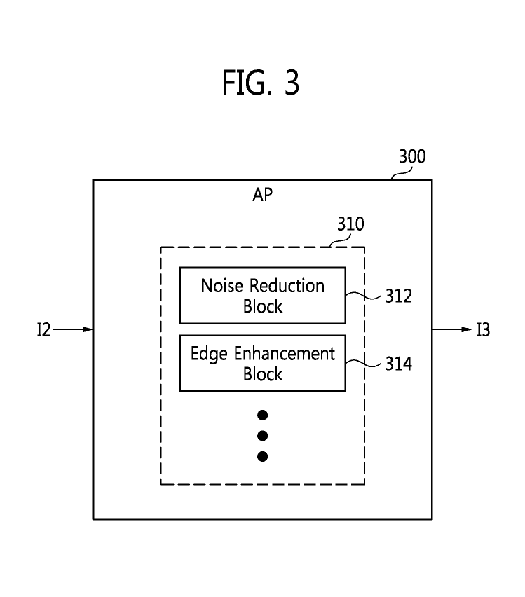

FIG. 3 is a schematic diagram of processing blocks included in the AP 300 illustrated in FIG. 1. Referring to FIGS. 1 through 3, the AP 300 may include a processing area 310 including a plurality of processing blocks 312 and 314 that process the second image I2 received from the ISP 200. The processing blocks 312 and 314 may include the noise reduction block 312 and the edge enhancement block 314. The noise reduction block 312 may remove noise from the second image I2, and the edge enhancement block 314 may enhance the edge of an object in the second image I2, so that the second image I2 is sharpened.

Although only the noise reduction block 312 and the edge enhancement block 314 are illustrated as processing blocks in FIG. 3, the processing blocks may include all function blocks involved with image processing operations in a conventional AP in other embodiments. For instance, the ISP 200 illustrated in FIG. 2 may further include the edge enhancement block 314 illustrated in FIG. 3 and the AP 300 illustrated in FIG. 3 may include the BPC block 222, the dynamic range compensation block 224, and the anti-shading block 226 illustrated in FIG. 2.

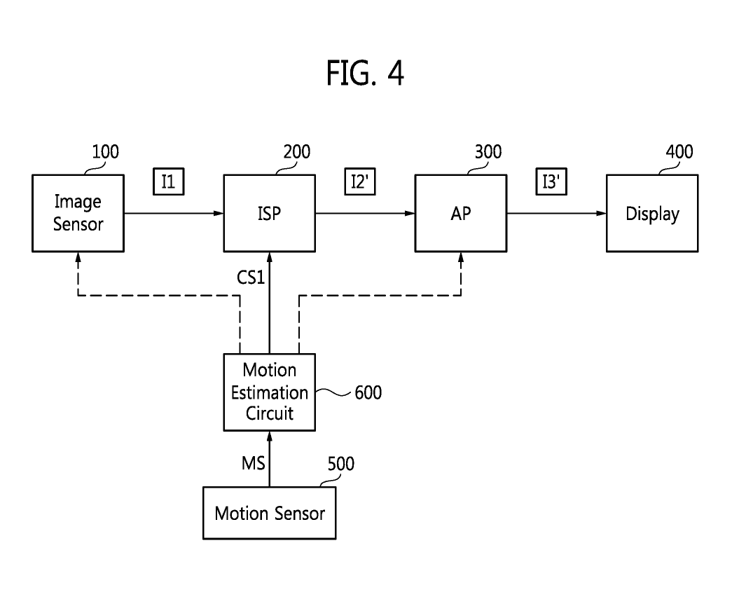

FIGS. 4 through 6 are diagrams showing the operations of the mobile computing device 1000 illustrated in FIG. 1 according to some embodiments of the inventive concepts. FIG. 4 shows embodiments in which the operation of the ISP 200 is controlled according to the first control signal CS1 enabled by the motion estimation circuit 600 when the current motion level of the mobile computing device 1000 analyzed by the motion estimation circuit 600 is equal to or higher than the reference level.

Referring to FIGS. 1, 2, and 4, the image sensor 100 may generate and transmit the first image I1 to the ISP 200. The ISP 200 may receive the first image I1 from the image sensor 100 and may process the first image I1. The ISP 200 may deactivate at least one among the processing blocks 222, 224, 226, and 228 included therein in response to the first control signal CS1 enabled by the motion estimation circuit 600. Accordingly, the ISP 200 may process the first image I1 using activated processing blocks among the processing blocks 222, 224, 226, and 228.

Since at least one deactivated block does not perform image processing, it does not consume power when the ISP 200 processes the first image I1. As a result, power consumed when the ISP 200 processes the first image I1 is decreased.

The ISP 200 may transmit a second image I2′ resulting from the processing of the first image I1 to the AP 300. The second image I2′ may have lower quality than the second image I2 illustrated in FIG. 1.

The AP 300 may receive the second image I2′ from the ISP 200 and may transmit a third image I3′ resulting from the processing of the second image I2′ to the display 400. The display 400 may display the third image I3′.

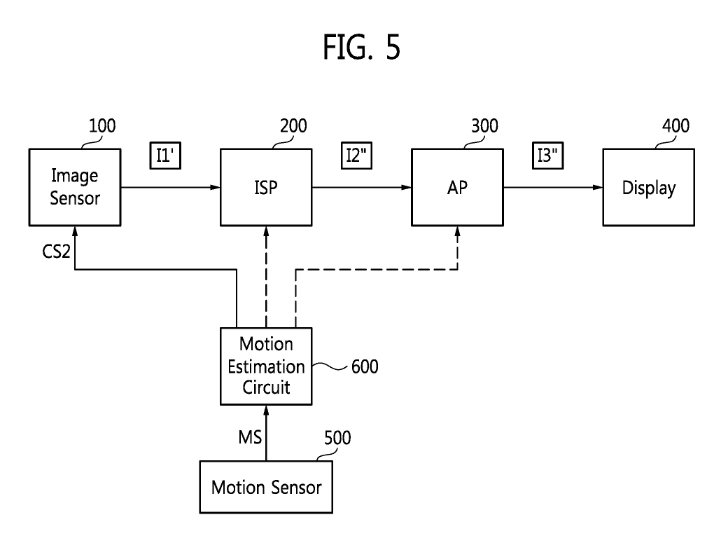

FIG. 5 shows embodiments in which the operation of the image sensor 100 is controlled according to a control signal output from the motion estimation circuit 600 when the future motion level of the mobile computing device 1000 analyzed by the motion estimation circuit 600 is equal to or higher than the reference level. Referring to FIGS. 1 and 5, the image sensor 100 may generate a first image I1′ having a frame rate lower than that of the first image I1 illustrated in FIG. 1 in response to the second control signal CS2 enabled by the motion estimation circuit 600, and may transmit the first image I1′ to the ISP 200.

The ISP 200 may receive the first image I1′ from the image sensor 100 and may process the first image I1′. The ISP 200 may transmit a second image I2″ resulting from the processing of the first image I1′ to the AP 300.

The AP 300 may receive the second image I2″ from the ISP 200 and may transmit a third image I3″ resulting from the processing of the second image I2″ to the display 400. The display 400 may display the third image I3″.

Since the image sensor 100 generates the first image I1′ at the frame rate lower than that of the first image I1 illustrated in FIG. 1, power consumption of the image sensor 100 may be decreased during image generation. In addition, the third image I3″ output by the display 400 may also have the lower frame rate, so that power consumption of the display 400 can also be decreased.

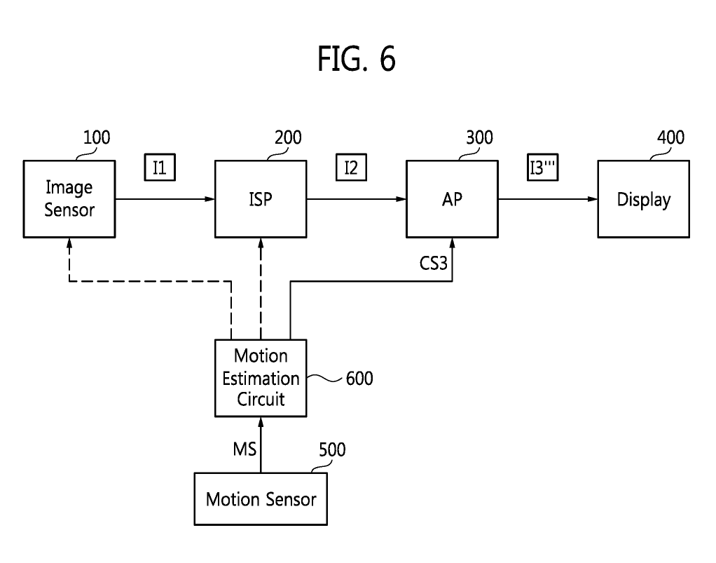

FIG. 6 shows embodiments in which the image processing operation of the AP 300 is controlled according to a control signal output from the motion estimation circuit 600 when the current motion level of the mobile computing device 1000 analyzed by the motion estimation circuit 600 is equal to or higher than the reference level. Referring to FIGS. 1, 3, and 6, the image sensor 100 may generate and transmit the first image I1 to the ISP 200. The ISP 200 may receive the first image I1 from the image sensor 100, and may transmit the second image I2 resulting from the processing of the first image I1 to the AP 300.

The AP 300 may deactivate at least one block among the processing blocks 312 and 314 included therein in response to the third control signal CS3 enabled by the motion estimation circuit 600. Accordingly, the AP 300 may process the second image I2 using an activated block among the processing blocks 312 and 314.

Since at least one deactivated block does not perform image processing, it may not consume power when the AP 300 processes the second image I2. As a result, power consumed when the AP 300 processes the second image I2 may be decreased.

The AP 300 may transmit a third image I3′″ resulting from the processing of the second image I2 to the display 400. The third image I3′″ may have lower quality than the third image I3 illustrated in FIG. 1. The display 400 may display the third image I3′″.

The motion estimation circuit 600 controls the image processing operation of one member among the image sensor 100, the ISP 200, and the AP 300, thereby decreasing the power consumption of at least one member in the embodiments illustrated in FIGS. 4 through 6. However, the motion estimation circuit 600 may decrease power consumption for the image processing operations of at least two members among the image sensor 100, the ISP 200, and the AP 300 in other embodiments.

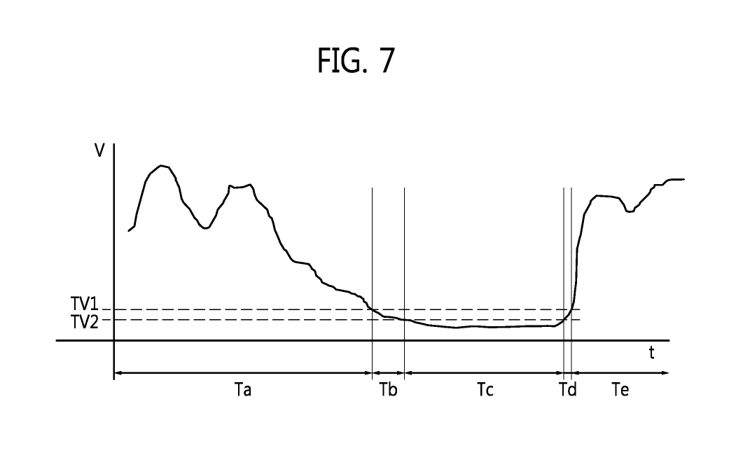

FIG. 7 is a graph explaining the operation of the motion estimation circuit 600 illustrated in FIG. 1. Referring to FIGS. 1 through 7, the motion sensor 500 may sense motion of the mobile computing device 1000 and may generate the motion signal MS corresponding to the sensed motion. The motion signal MS may indicate a level (or a magnitude) of motion of the mobile computing device 1000. The motion sensor 500 may transmit the motion signal MS to the motion estimation circuit 600. In the graph illustrated in FIG. 7, the horizontal axis is time “t” and the vertical axis is a motion level (or magnitude) V.

The motion estimation circuit 600 may analyze the motion signal MS received from the motion sensor 500. In detail, the motion estimation circuit 600 may analyze the motion signal MS for a desired (or, alternatively a predetermined) period of time, and may determine a current motion state and/or a future motion state of the mobile computing device 1000 based on the analysis result.

When the motion signal MS is higher than a second reference level TV2 in sections Ta and Tb, the motion estimation circuit 600 may determine the current motion state of the mobile computing device 1000 as a state where an image generated and processed by the image processing system 10 is not being used by a user. Accordingly, the motion estimation circuit 600 may issue at least one of the control signals CS1 and/or CS3 to the ISP 200 and/or the AP 300 included in the image processing system 10 to decrease the power consumption of the ISP 200 and/or the AP 300.

When the motion signal MS is lower than the second reference level TV2 in a section Tc, the motion estimation circuit 600 may determine the current motion state of the mobile computing device 1000 as a state where an image generated and processed by the image processing system 10 is being used by a user. Accordingly, the motion estimation circuit 600 may issue at least one of the control signals CS1 and/or CS3 to the ISP 200 and/or the AP 300 included in the image processing system 10 not to decrease the power consumption of the ISP 200 and/or the AP 300.

When the motion signal MS is higher than the second reference level TV2 in sections Td and Te, the motion estimation circuit 600 may determine the current motion state of the mobile computing device 1000 as a state where an image generated and processed by the image processing system 10 is not being used by a user. Accordingly, the motion estimation circuit 600 may issue at least one of the control signals CS1 and/or CS3 to the ISP 200 and/or the AP 300 included in the image processing system 10 to decrease the power consumption of the ISP 200 and/or the AP 300.

When the motion signal MS is higher than a first reference level TV1 in the section Ta, the motion estimation circuit 600 may determine the future motion state of the mobile computing device 1000 as a state where an image to be generated and processed by the image processing system 10 will not be used by a user. Accordingly, the motion estimation circuit 600 may issue the second control signal CS2 to the image sensor 100 included in the image processing system 10 to decrease the power consumption of the image sensor 100. The image sensor 100 may lower a capture frame rate of the image in response to the second control signal CS2.

When the motion signal MS is lower than the first reference level TV1 in the section Tb, the motion estimation circuit 600 may determine the future motion state of the mobile computing device 1000 as a state where an image to be generated and processed by the image processing system 10 will be used by a user. Accordingly, the motion estimation circuit 600 may issue the second control signal CS2 to the image sensor 100 included in the image processing system 10 not to decrease the power consumption of the image sensor 100. The image sensor 100 may raise a capture frame rate of the image in response to the second control signal CS2 so that an image generated by the image sensor 100 can be used by the user in the section Tc where the motion signal MS is lower than the second reference level TV2.

When the motion signal MS is higher than the second reference level TV2 in the sections Td and Te, the motion estimation circuit 600 may determine the future motion state of the mobile computing device 1000 as a state where an image to be generated and processed by the image processing system 10 will not be used by a user. Accordingly, the motion estimation circuit 600 may issue the second control signal CS2 to the image sensor 100 included in the image processing system 10 to decrease the power consumption of the image sensor 100. The image sensor 100 may lower a capture frame rate of the image in response to the second control signal CS2.

Although the motion estimation circuit 600 determines the current motion state and/or the future motion state of the mobile computing device 1000 using two reference levels TV1 and TV2 in the embodiments illustrated in FIG. 7, the number and magnitudes of reference levels may vary. The embodiments described with reference to FIG. 7 are examples provided for convenience' sake, and methods for determining the current motion state and the future motion state may be variously modified in other embodiments.

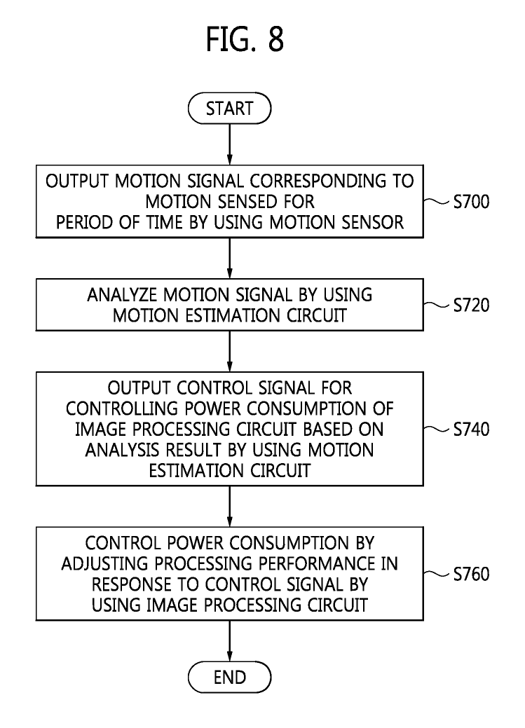

FIG. 8 is a flowchart of a method of operating the mobile computing device 1000 according to some embodiments of the inventive concepts. Referring to FIGS. 1 through 8, the motion sensor 500 may sense motion of the mobile computing device 1000 for a desired (or, alternatively a predetermined) period of time and may output the motion signal MS corresponding to the sensed motion in operation S700.

The motion estimation circuit 600 may receive and analyze the motion signal MS in operation S720. The motion estimation circuit 600 may determine a current motion state and/or a future motion state of the mobile computing device 1000 based on the result of analyzing the motion signal MS.

The motion estimation circuit 600 may output at least one of the control signals CS1, CS2, and/or CS3 for controlling power consumption of an image processing circuit based on the analysis result in operation S740. The image processing circuit may include the image sensor 100, the ISP 200, and/or the AP 300 illustrated in FIG. 1. The image processing circuit may adjust image processing performance in response to at least one of the control signals CS1, CS2, and/or CS3 output from the motion estimation circuit 600, thereby controlling its power consumption.

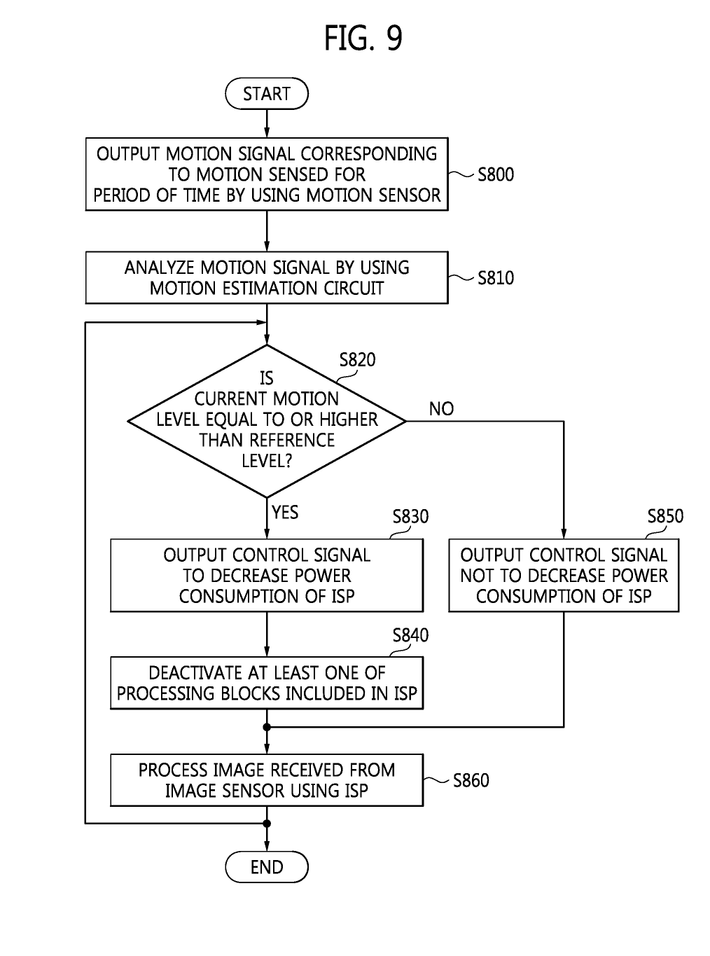

FIG. 9 is a flowchart of a method of operating the ISP 200 included in the mobile computing device 1000 according to some embodiments of the inventive concepts. Referring to FIGS. 1, 2, and 4 and FIGS. 7 through 9, the motion sensor 500 may sense motion of the mobile computing device 1000 for a desired (or, alternatively a predetermined) period of time and output the motion signal MS corresponding to the sensed motion in operation S800.

The motion estimation circuit 600 may receive and analyze the motion signal MS in operation S810. The motion estimation circuit 600 may determine a current motion state of the mobile computing device 1000 based on the result of analyzing the motion signal MS. When the current motion state (or level) is equal to or higher than a reference level (in case of YES) in operation S820, the motion estimation circuit 600 may output the first control signal CS1 for decreasing the power consumption of the ISP 200 in operation S830.

When processing the first image I1 received from the image sensor 100 and generating the second image I2, the ISP 200 may deactivate at least one of the processing blocks 222, 224, 226, and 228 included therein in response to the first control signal CS1 in operation S840. The ISP 200 may process the first image I1 using only activated processing blocks in operation S860. For instance, as shown in FIGS. 1 and 4, the ISP 200 that processes the first image I1 and generates the second image I2 may process the first image I1 in response to the first control signal CS1 to generate the second image I2′ having lower quality than the second image I2 illustrated in FIG. 1.

When the current motion state (or level) is lower than the reference level (in case of NO) in operation S820, the motion estimation circuit 600 may output the first control signal CS1 not to decrease the power consumption of the ISP 200 in operation S850. In response to the first control signal CS1, the ISP 200 may process the first image I1 received from the image sensor 100 to generate the second image I2 in operation S860.

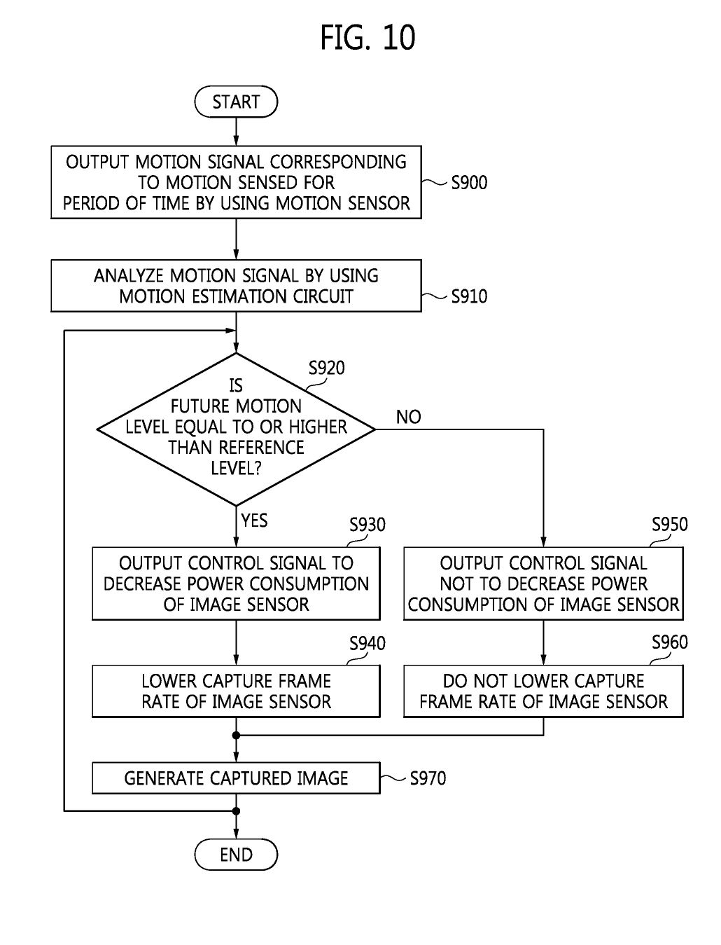

FIG. 10 is a flowchart of a method of operating the image sensor 100 included in the mobile computing device 1000 according to some embodiments of the inventive concepts. Referring to FIGS. 1 and 5 and FIGS. 7 through 10, the motion sensor 500 may sense motion of the mobile computing device 1000 for a desired (or, alternatively a predetermined) period of time and may output the motion signal MS corresponding to the sensed motion in operation S900.

The motion estimation circuit 600 may receive and analyze the motion signal MS in operation S910. The motion estimation circuit 600 may determine a future motion state of the mobile computing device 1000 based on the result of analyzing the motion signal MS. When the future motion state (or level) is equal to or higher than a reference level (in case of YES) in operation S920, the motion estimation circuit 600 may output the second control signal CS2 for decreasing the power consumption of the image sensor 100 in operation S930.

The image sensor 100 may lower a capture frame rate for a captured image (i.e., the first image I1) in response to the second control signal CS2 in operation S940 and may generate the captured image at the lowered capture frame rate in operation S970. For instance, as shown in FIGS. 1 and 5, the image sensor 100 that generates the first image I1 may generate the first image I1′ having a frame rate lower than that of the first image I1 in response to the second control signal CS2.

When the future motion state (or level) is lower than the reference level (in case of NO) in operation S920, the motion estimation circuit 600 may output the second control signal CS2 not to decrease the power consumption of the image sensor 100 in operation S950. In response to the second control signal CS2, the image sensor 100 may not lower the capture frame rate in response to the second control signal CS2 in operation S960 and may generate the first image I1 in operation S970.

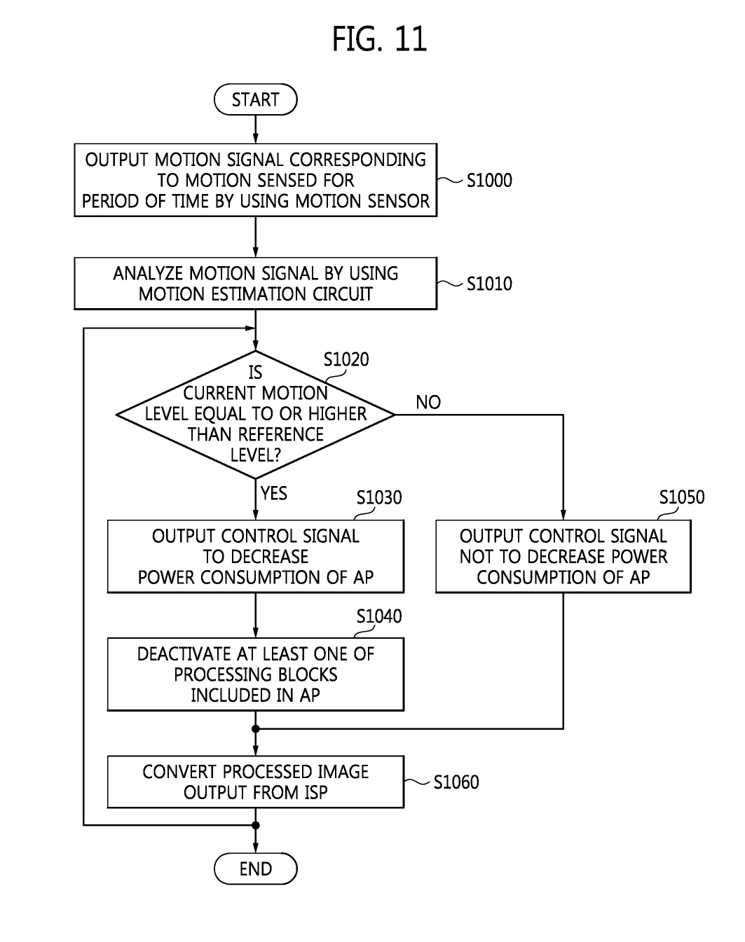

FIG. 11 is a flowchart of a method of operating the AP 300 included in the mobile computing device 1000 according to some embodiments of the inventive concepts. Referring to FIGS. 1 and 3 and FIGS. 6 through 11, the motion sensor 500 may sense motion of the mobile computing device 1000 for a desired (or, alternatively a predetermined) period of time and may output the motion signal MS corresponding to the sensed motion in operation S1000.

The motion estimation circuit 600 may receive and analyze the motion signal MS in operation S1010. The motion estimation circuit 600 may determine a current motion state of the mobile computing device 1000 based on the result of analyzing the motion signal MS. When the current motion state (or level) is equal to or higher than a reference level (in case of YES) in operation S1020, the motion estimation circuit 600 may output the third control signal CS3 for decreasing the power consumption of the AP 300 in operation S1030.

When converting a processed image (e.g., the second image I2) received from the ISP 200 and generating a display image (e.g., the third image I3), the AP 300 may deactivate at least one of the processing blocks 312 and 314 included therein in response to the third control signal CS3 in operation S1040. The AP 300 may convert (or process) the processed image using only activated processing block in operation S1060. For instance, as shown in FIGS. 1 and 6, the AP 300 that processes the second image I2 and generates the third image I3 may process the second image I2 in response to the third control signal CS3 to generate the third image I3′″ having lower quality than the third image I3 illustrated in FIG. 1.

When the current motion state (or level) is lower than the reference level (in case of NO) in operation S1020, the motion estimation circuit 600 may output the third control signal CS3 not to decrease the power consumption of the AP 300 in operation S1050. In response to the third control signal CS3, the AP 300 may convert (or process) the second image I2 received from the ISP 200 to generate the third image I3 in operation S1060.

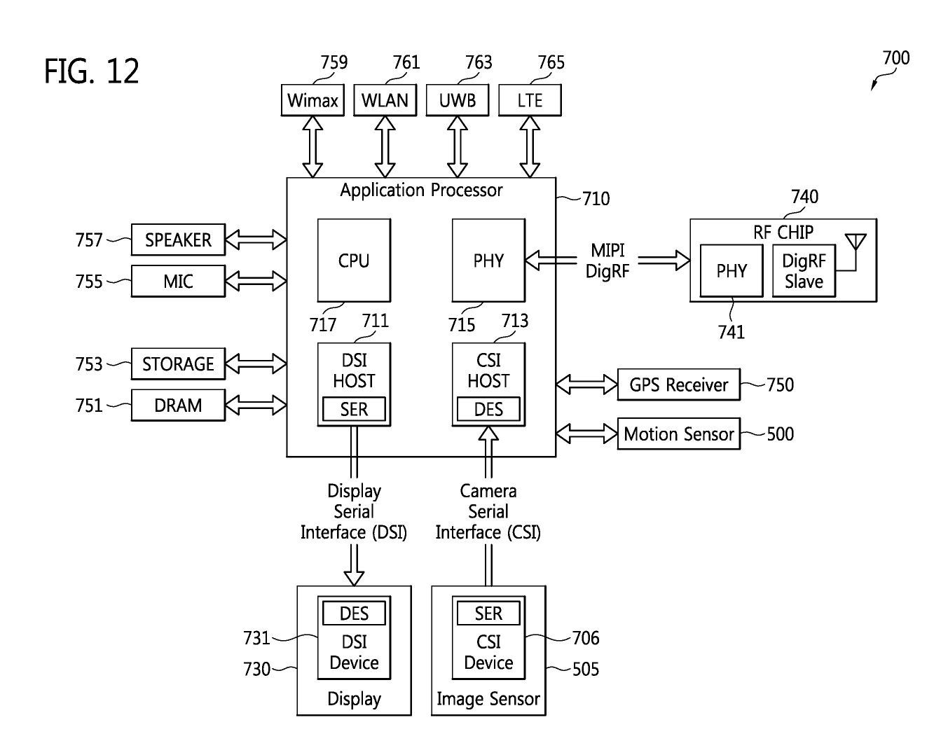

FIG. 12 is a block diagram of a data processing system 700 according to some embodiments of the inventive concepts. Referring to FIGS. 1 through 12, the data processing system 700 may use or support mobile industry processor interface (MIPI®). The data processing system 700 may be implemented as a portable electronic device. The portable electronic device may be a mobile computing device such as a laptop computer, a cellular phone, a smart phone, a tablet personal computer (PC), a digital camera, a camcorder, a mobile internet device (MID), a wearable computer, an internet of things (IoT) device, or an internet of everything (IoE) device. The data processing system 700 includes an AP 710, an image sensor 505, and a display 730.

The AP 710 may be substantially the same as or similar to the AP 300 illustrated in FIG. 1. The image sensor 505 may be substantially the same as or similar to the image sensor 100 illustrated in FIG. 1. The display 730 may be substantially the same as or similar to the display 400 illustrated in FIG. 1.

A camera serial interface (CS1) host 713 in the AP 710 may perform serial communication with a CS1 device 706 in the image sensor 505 through CS1. A deserializer DES and a serializer SER may be included in the CS1 host 713 and the CS1 device 706, respectively. The image sensor 505 may be implemented as a front side illuminated (FSI) CMOS image sensor or a back side illuminated (BSI) CMOS image sensor.

A display serial interface (DSI) host 711 in the AP 710 may perform serial communication with a DSI device 731 in the display 730 through DSI. A serializer SER and a deserializer DES may be included in the DSI host 711 and the DSI device 731, respectively. Image data output from the image sensor 505 may be transmitted to the AP 710 through CS1. The AP 710 may process the image data and may transmit processed image data to the display 730 through DSI.

The data processing system 700 may also include a radio frequency (RF) chip 740 communicating with the AP 710. A physical layer (PHY) 715 in the AP 710 and a PHY 741 in the RF chip 740 may communicate data with each other according to MIPI DigRF.

A central processing unit (CPU) 717 in the AP 710 may control the operations of the DSI host 711, the CS1 host 713, and the PHY 715. The CPU 717 may include at least one core. The AP 710 may be implemented in an integrated circuit (IC) or a system on chip (SoC). The AP 710 may be a processor or a host that can control the operations of the image sensor 505.

Referring to FIGS. 1 and 12, the image sensor 505 or the AP 710 may include the ISP 200 according to some embodiments of the inventive concepts. The ISP 200 may be implemented in a separate chip in other embodiments.

The data processing system 700 may further include a global positioning system (GPS) receiver 750, a volatile memory 751 such as dynamic random access memory (DRAM), a data storage 753 including non-volatile memory such as flash-based memory, a microphone (MIC) 755, and/or a speaker 757. The data storage 753 may be implemented as an external memory detachable from the AP 710. The data storage 753 may also be implemented as a universal flash storage (UFS), a multimedia card (MMC), an embedded MMC (eMMC), or a memory card.

The data processing system 700 may communicate with external devices using at least one communication protocol, e.g., worldwide interoperability for microwave access (Wimax) 759, wireless local area network (WLAN) 761, ultra-wideband (UWB) 763, and/or long term evolution (LTETM) 765. In other embodiments, the data processing system 700 may also include a near field communication (NFC) module, a Wi-Fi module, and/or a Bluetooth module.

The data processing system 700 may also include the motion sensor 500. The motion sensor 500 may transmit a motion signal to the motion estimation circuit 600. The motion estimation circuit 600 may be included in any one among the image sensor 505, the AP 710, and the ISP 200 or may be implemented in a separate chip.

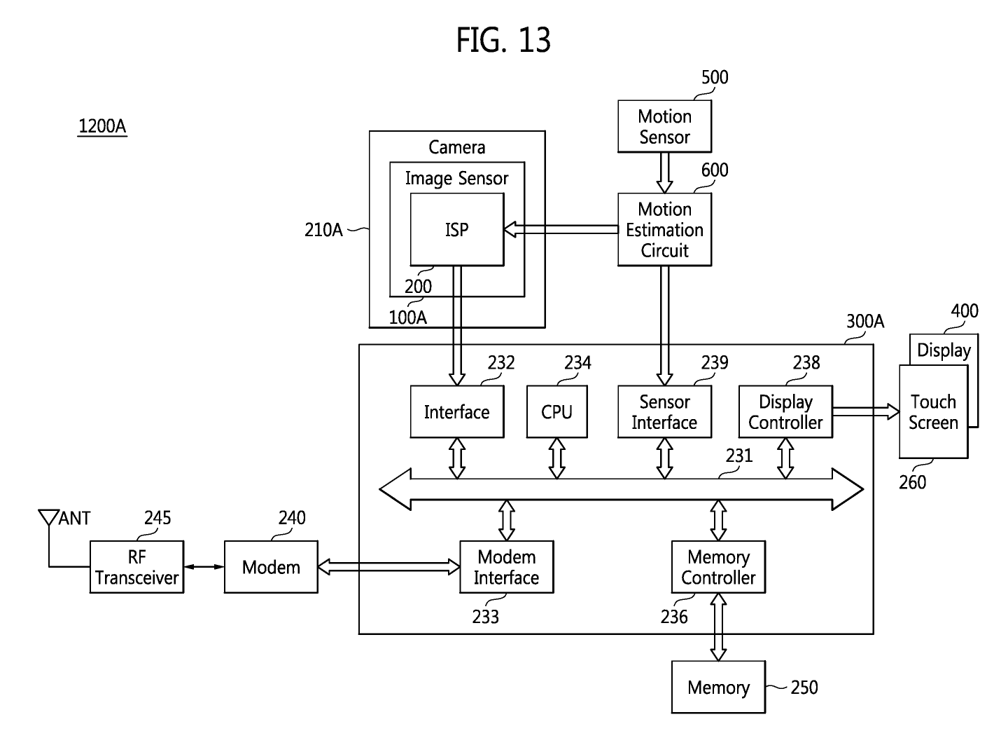

FIG. 13 is a block diagram of a computing device 1200A according to some embodiments of the inventive concepts. Referring to FIGS. 1 through 11 and FIG. 13, the computing device 1200A may be the mobile computing device 1000. The mobile computing device 1000 may be implemented as a laptop computer, a cellular phone, a smart phone, a tablet PC, a personal digital assistant (PDA), an enterprise digital assistant (EDA), a digital still camera, a digital video camera, a portable multimedia player (PMP), a personal navigation device or portable navigation device (PND), a handheld game console, a MID, a wearable computer, an IoT device, an IoE device, or an e-book. The computing device 1200A may include a camera 210A including an image sensor 100A, an AP 300A, a modem 240, an RF transceiver 245, a memory 250, and the display 400 including a touch screen 260.

The image sensor 100A may convert an optical image into an electrical signal. The camera 210A may generate image data using the image sensor 100A. The ISP 200 may process the image data and may output processed image data to the AP 300A through the interface 232.

The RF transceiver 245 may transmit radio data received through an antenna ANT to the modem 240. The RF transceiver 245 may also convert data output from the modem 240 into radio data and output the radio data through the antenna ANT.

The modem 240 may process data transferred between the RF transceiver 245 and the AP 300A. The AP 300A may control the camera 210A, the modem 240, the RF transceiver 245, the memory 250, the touch screen 260, and/or the display 400. The AP 300A may be implemented as an IC, an SoC, or a mobile AP. The AP 300A may include bus architecture 231, the interface 232, a modem interface 233, a CPU 234, a memory controller 236, and a display controller 238.

The CPU 234 may control the interface 232, the modem interface 233, the memory controller 236, and the display controller 238 through the bus architecture 231. The bus architecture 231 may be implemented as advanced microcontroller bus architecture (AMBA), an advanced high-performance bus (AHB), an advanced peripheral bus (APB), an advanced extensible interface (AXI), or an advanced system bus (ASB), but the inventive concepts is not restricted to these examples.

The interface 232 may transmit image data from the ISP 200 to the bus architecture 231. The modem interface 233 may control processing and/or transmission of data communicated with the modem 240 according to the control of the CPU 234.

The memory controller 236 may control an access operation on the memory 250 according to the control of the CPU 234. The access operation may include a write operation for writing data to the memory 250 and a read operation for reading data from the memory 250.

The memory 250 may include at least one of volatile memory and non-volatile memory. Although one memory controller 236 and one memory 250 are illustrated in FIG. 13, the memory controller 236 may refer to a group of memory controllers for controlling different types of memory devices, and the memory 250 may refer to a group of different types of memory devices. The memory 250 may be formed of DRAM. Alternatively, the memory 250 may be formed of a flash-based memory such as a NAND-type flash memory, a NOR-type flash memory, an MMC, an eMMC, or a UFS. However, the inventive concepts is not restricted to these examples.

The display controller 238 may transmit data to be displayed on the display 400 to the display 400 according to the control of the CPU 234. The display controller 238 and the display 400 may communicate data with each other using MIPI® DSI or embedded DisplayPort (eDP).

The touch screen 260 may transmit a user input for controlling the operation of the computing device 1200A to the AP 300A. The user input may be generated when the computing device 1200A touches the touch screen 260. The CPU 234 may control the operation of at least one member among the camera 210A, the AP 300A, the memory 250, and the display 400 according to the user input received from the touch screen 260.

The computing device 1200A may also include the motion sensor 500 and the motion estimation circuit 600. The motion sensor 500 may sense motion of the computing device 1200A and may output the motion signal MS corresponding to the sensed motion. The motion sensor 500 may be implemented as an acceleration sensor, a gyro sensor, a geo-magnetic sensor, a gyroscope, or a gyrocompass, but the inventive concepts is not restricted to these examples.

The motion estimation circuit 600 may analyze the motion signal MS output from the motion sensor 500 and may output at least one of the control signals CS1, CS2, and CS3 for controlling power consumption of at least one member among the image sensor 100A, the ISP 200, and the AP 300A based on the analysis result. The motion estimation circuit 600 may be included in the ISP 200 or the AP 300A, or may be implemented in a separate chip in other embodiments.

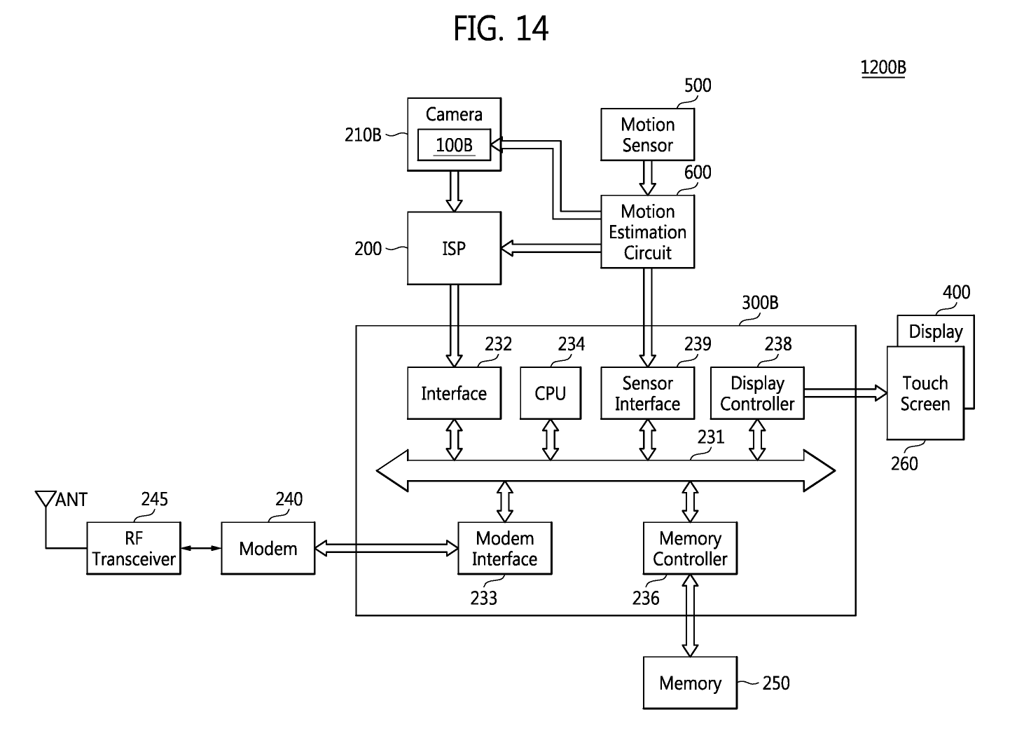

FIG. 14 is a block diagram of a computing device 1200B according to other embodiments of the inventive concepts. Referring to FIGS. 1 through 11 and FIGS. 13 and 14, the structure and operations of the computing device 1200B illustrated in FIG. 14 are substantially the same as or similar to those of the computing device 1200A illustrated in FIG. 13 except for an image sensor 100B, the ISP 200, and a camera 210B.

Referring to FIG. 14, the ISP 200 may be provided between the image sensor 100B and an AP 300B or between the camera 210B and the AP 300B. The ISP 200 may receive and process image data output from the image sensor 100B or the camera 210B, and may output processed image data to the AP 300B. The structure and operations of the AP 300B may be substantially the same as or similar to those of the AP 300A illustrated in FIG. 13.

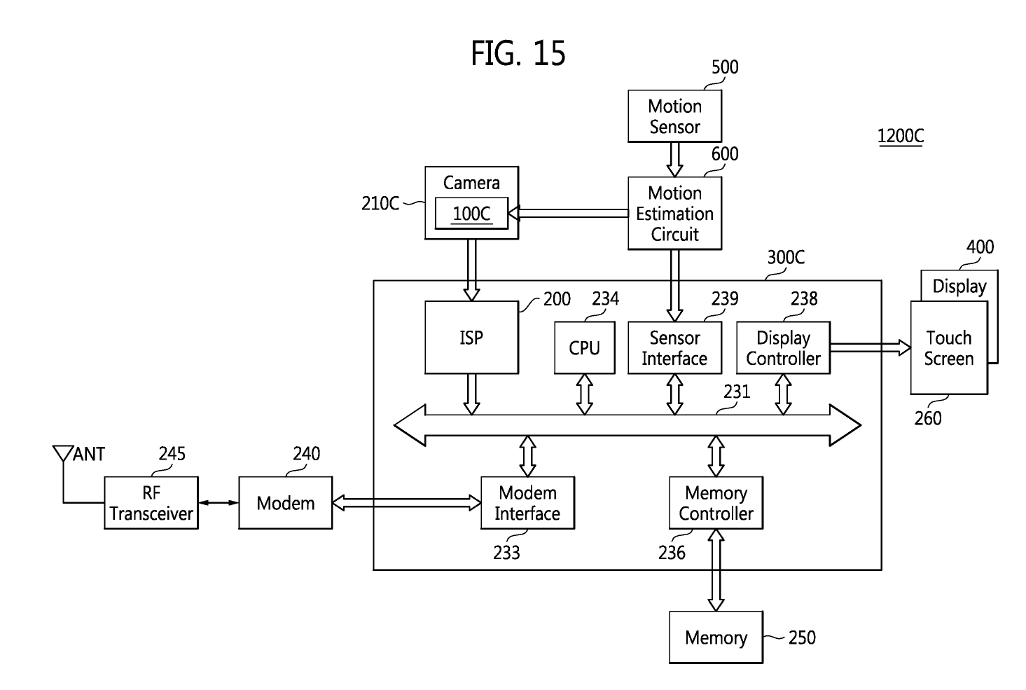

FIG. 15 is a block diagram of a computing device 1200C according to further embodiments of the inventive concepts. Referring to FIGS. 14 and 15, the structure and operations of the computing device 1200C including an AP 300C illustrated in FIG. 15 are substantially the same as or similar to those of the computing device 1200B including the AP 300B illustrated in FIG. 14 except for the ISP 200 and the interface 232.

Referring to FIG. 15, the ISP 200 may be included in the AP 300C. The ISP 200 may receive and process image data output from an image sensor 100C and may output processed image data to the bus architecture 231. The image sensor 100C and a camera 210C illustrated in FIG. 15 may be substantially the same as the image sensor 100B and the camera 210B illustrated in FIG. 14.

As described above, according to some embodiments of the inventive concepts, an image processing system determines a period during which the system is not actually used based on motion information and decreases power consumption for image generation and processing according to the determination result.

While the inventive concepts has been particularly shown and described with reference to example embodiments thereof, it will be understood by those of ordinary skill in the art that various changes in forms and details may be made therein without departing from the spirit and scope of the inventive concepts as defined by the following claims.

What is claimed is:

1. An image processing system comprising:
a motion estimation circuit configured to receive and analyze a motion signal, and configured to generate a control signal based on an analysis result; and
an image processing circuit configured to selectively decrease power consumption for an image processing operation in response to the control signal.

2. The image processing system of claim 1, wherein the image processing circuit includes an image signal processor,
the image signal processor is configured to decrease the power consumption for the image processing operation by deactivating at least one block among a plurality of processing blocks included in the image signal processor, and
the plurality of processing blocks include at least one block among a bad pixel correction block, a nose reduction block, a dynamic range compensation block, and an anti-shading block.

3. The image processing system of claim 2, wherein the motion estimation circuit is configured to determine a current motion state based on the analysis result and generate the control signal according to the current motion state.

4. The image processing system of claim 1, wherein
the image processing circuit includes an image sensor which is configured to generate a first image having a first frame rate, and
the image sensor is configured to generate a second image having a second frame rate lower than the first frame rate in response to the control signal.

5. The image processing system of claim 4, wherein the motion estimation circuit is configured to predict a future motion state based on the analysis result, and generate the control signal according to the future motion state.

6. The image processing system of claim 1, wherein the image processing circuit includes an application processor (AP),
the AP is configured to decrease the power consumption for the image processing operation by deactivating at least one block among a plurality of processing blocks included in the AP, and
the plurality of processing blocks include at least one block among a nose reduction block and an edge enhancement block.

7. The image processing system of claim 6, wherein the motion estimation circuit is configured to determine a current motion state based on the analysis result, and generates the control signal according to the current motion state.

8. The image processing system of claim 1, wherein the motion estimation circuit is configured to output the control signal when the motion signal is higher than a reference level.

9. The image processing system of claim 1, wherein the motion signal is received from a motion sensor included in the mobile computing device.

10. A mobile computing device comprising:
a motion sensor configured to sense motion of the mobile computing device for a period of time, and configured to output a motion signal;
a motion estimation circuit configured to receive and analyze the motion signal, and configured to generate a control signal based on an analysis result; and
an image processing circuit configured to selectively decrease power consumption for an image processing operation in response to the control signal,
wherein the image processing circuit includes an image sensor configured to convert an optical image into an electrical signal, and an image signal processor configured to decrease the power consumption for the image processing operation by deactivating at least one block among a plurality of processing blocks included in the image signal processor.

11. The mobile computing device of claim 10, wherein
the motion estimation circuit is configured to determine a current motion state based on the analysis result, and generate the control signal according to the current motion state, and
the plurality of processing blocks include at least one block among a bad pixel correction block, a nose reduction block, a dynamic range compensation block, and an anti-shading block.

12. The mobile computing device of claim 10, wherein
the motion estimation circuit is configured to predict a future motion state based on the analysis result, and generate the control signal according to the future motion state, and
the image sensor generate a first image having a first frame rate, and
the image sensor is configured to generate a second image having a second frame rate lower than the first frame rate in response to the control signal.

13. The mobile computing device of claim 10, wherein
the motion estimation circuit is configured to determine a current motion state based on the analysis result, and is configured to generate the control signal according to the current motion state,
the image processing circuit includes an application processor (AP),
the AP is configured to decrease the power consumption for the image processing operation by deactivating at least one block among a plurality of processing blocks included in the AP, and
the plurality of processing blocks comprise at least one block among a nose reduction block and an edge enhancement block.

14. The mobile computing device of claim 13, further comprising:
a display configured to display an image.

15. The mobile computing device of claim 10, wherein the motion estimation circuit is configured to output the control signal when the motion signal is higher than a reference level.

16. A method of operating a mobile computing device, the method comprising:
receiving and analyzing a motion signal output from a motion sensor included in the mobile computing device;
generating a control signal based on an analysis result; and
selectively decreasing power consumption of an image processing circuit, which processes an image in the mobile computing device, based on the control signal.

17. The method of claim 16, wherein the selectively decreasing the power consumption comprises selectively deactivating, by an image signal processor included in the image processing circuit, at least one block among a plurality of processing blocks included in the image signal processor, based on the control signal, the plurality of processing blocks comprising at least one block among a bad pixel correction block, a nose reduction block, a dynamic range compensation block, and an anti-shading block.

18. The method of claim 16, wherein the image processing circuit includes an image sensor which generates a first image having a first frame rate, and
the selectively decreasing the power consumption comprises generating, by the image sensor, a second image having a second frame rate lower than the first frame rate based on the control signal.

19. The method of claim 16, wherein the image processing circuit includes an application processor (AP), and
the selectively decreasing the power consumption comprises selectively deactivating, by the AP, at least one block among a plurality of processing blocks included in the AP, the plurality of processing blocks comprising at least one block among a nose reduction block and an edge enhancement block.

20. The method of claim 16, wherein the generating the control signal comprises:
analyzing a magnitude of the motion signal using a reference level;
determining at least one state among a current motion state and a future motion state of the mobile computing device based on a result of analyzing the magnitude of the motion signal; and
generating the control signal based on a determination result.
